(19) United States
(12) Patent Application Publication
(10) Pub. No.: US 2023/0061611 A1
(43) Pub. Date: Mar. 2, 2023

(54) SYSTEMS, DEVICES, AND METHODS FOR FACILITY CONTROL

(71) Applicant: Tracer Golf Inc., North York (CA)

(72) Inventors: Tosan Lee, North York (CA); Toro Lee, Maple (CA)

(21) Appl. No.: 17/459,047

(22) Filed: Aug. 27, 2021

(51) Int. Cl. G05B 19/042; G06Q 10/02

(52) U.S. Cl. CPC G05B 19/042; G06Q 10/02; G05B 2219/23027; G05B 2219/24167

(57) ABSTRACT

Computer-implemented methods and systems for controlling a facility and configurable components are described. A method includes receiving an authentication indicator representing authentication of a user login to a user account accessible from a mobile application at a user device; receiving a request from the user account for access to one or more components of the facility; generating one or more queries to one or more databases based on the request; validating the request using the one or more queries to determine whether an access key should be granted; if the access key should be granted, generating the access key and presenting the access key at a user interface of the mobile application, the user interface accessible using the user account; upon actuation of the access key, enabling access to the one or more components of the facility. The components can be configurable components.

### FIELD OF THE INVENTION

The present specification relates generally to computer systems and more specifically to remote computer control of facilities and components.

### BACKGROUND OF THE INVENTION

Facilities, such as indoor golfing facilities and gyms, as well as equipment and other components of the facility can be accessible by many different users. Such access must be restricted, and access must be provided in a timely manner. Computer systems are limited in their capability to provide reliable and customized functionality for maintaining timely access to such facilities and control of components.

### SUMMARY OF THE INVENTION

According to an aspect, there is provided a computer-implemented method for controlling a facility. The method includes receiving an authentication indicator representing authentication of a user login to a user account accessible from a mobile application at a user device, receiving a request from the user account for access to one or more components of the facility; generating one or more queries to one or more databases based on the request and to validate the request; validating the request using the one or more queries to determine whether an access key should be granted. If the access key should be granted, the method further includes generating the access key and presenting the access key at a user interface of the mobile application, the user interface accessible using the user account. Upon actuation of the access key, the method includes enabling access to the one or more components of the facility.

In some embodiments, the request comprises a user identifier and a present time indicator.

In some embodiments, the validation further includes: (a) identifying a booking in the one or more databases, the booking for a user identifier associated with the user account; and (b) determining whether a present time is in a range of times from a start time of the booking to an end time of the booking; and wherein the access key should be granted where (a) and (b) are true.

In some embodiments, the start time includes an offset start time from an original start time of the booking and the end time includes an offset end time from an original end time of the booking.

In some embodiments, the access key is a URL, wherein upon access of the URL, the access key is actuated.

In some embodiments, the access key is a keypad code, a QR code, or is transmitted using near-field communication.

In some embodiments, enabling access to the one or more components of the facility further includes transmitting a command to the one or more components of the facility.

In some embodiments, the request is generated upon access of a page on the user interface, the page corresponding to the one or more components of the facility.

In some embodiments, the user identifier is a user email address.

In some embodiments, the method further includes storing a booking in one or more of the one or more databases, the booking comprising an original start time, an original end time, and a user identifier.

In some embodiments, one or more of the one or more components of the facility comprise a door for entry to the facility or equipment or both.

In some embodiments, the one or more components of the facility is one or more configurable components; and wherein the access key is a configurable token for receiving a command to configure the one or more configurable components; and wherein the enabling of access is configuring the one or more configurable components based on the command.

According to an aspect, there is provided a computer-implemented system for controlling a facility, the system including: a computing device comprising a processor and a non-transitory computer-readable memory with instructions thereon which when executed carry out the steps of: receiving an authentication indicator representing authentication of a user login to a user account accessible from a mobile application at a user device, receiving a request from the user account for access to one or more components of the facility; generating one or more queries to one or more databases based on the request and to validate the request; validating the request using the one or more queries to determine whether an access key should be granted. If the access key should be granted, the steps further include generating the access key and presenting the access key at a user interface of the mobile application, the user interface accessible using the user account. Upon actuation of the access key, the steps further include enabling access to the one or more components of the facility.

In some embodiments, the request comprises a user identifier and a present time indicator.

In some embodiments, the validation further comprises: (a) identifying a booking in the one or more databases, the booking for a user identifier associated with the user account; and (b) determining whether a present time is in a range of times based on a start time of the booking to an end time of the booking; and wherein the access key should be granted where (a) and (b) are true.

In some embodiments, the access key is a URL, wherein upon access of the URL, the access key is actuated.

In some embodiments, the request is generated upon access of a page on the user interface, the page corresponding to the one or more components of the facility.

In some embodiments, the steps further comprise storing a booking in one or more of the one or more databases, the booking comprising an original start time, an original end time, and a user identifier.

In some embodiments, the one or more components of the facility is one or more configurable components; and wherein the access key is a configurable token for receiving a command to configure the one or more configurable components; and wherein the enabling of access is configuring the one or more configurable components based on the command.

According to an aspect, there is provided a non-transient computer-readable medium containing computer-readable instructions which, when executed by a computer processor, perform a method of: receiving an authentication indicator representing authentication of a user login to a user account accessible from a mobile application at a user device, receiving a request from the user account for access to one or more components of the facility; generating one or more queries to one or more databases based on the request and to validate the request; and validating the request using the one or more queries to determine whether an access key should be granted. If the access key should be granted, the method further includes generating the access key and presenting the access key at a user interface of the mobile application, the user interface accessible using the user account. Upon actuation of the access key, the method includes enabling access to the one or more components of the facility.

Other aspects and features according to the present application will become apparent to those ordinarily skilled in the art upon review of the following description of embodiments of the invention in conjunction with the accompanying figures.

### BRIEF DESCRIPTION OF THE FIGURES

The principles of the invention may better be understood with reference to the accompanying figures provided by way of illustration of an exemplary embodiment, or embodiments, incorporating principles and aspects of the present invention, and in which:

FIG. 1 shows a control system for control of a facility, according to an embodiment;

FIG. 2 shows a process for control of a facility, according to an embodiment;

FIG. 3 shows a process for control of a facility, according to an embodiment;

FIG. 4 shows a process for control of a facility, according to an embodiment;

FIG. 5A shows a process for control of a facility, according to an embodiment; and

FIG. 5B shows a process for control of a facility, according to an embodiment.

### DETAILED DESCRIPTION OF EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order to more clearly to depict certain features of the invention.

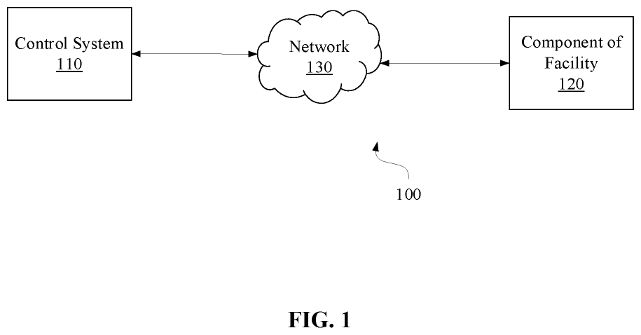

FIG. 1 shows an example control platform 100, including control system 110, one or more components 120 of a facility, and network 130, according to some embodiments. Control system 110 is configured to receive a request for access to one or more components 120 of the facility. The request for access can be received from a remote computer (e.g., mobile device) and associated with a user profile. For example, a user can login to their user profile via a mobile device application implementing a user interface for the control system 110 and the mobile device application can be configured to transmit the request for access. In an embodiment, the request for access is not associated with a user profile. For example, the request can include a unique and/or randomly generated URL that a user receives. According to some embodiments, the request includes one or more booking times. The request can also include other attributes, such as a user identifier associated with the user profile for uniquely identifying the user, metadata, and/or identification of one or more other components or types of components (e.g., equipment, technology, lighting, appliances, or components related to same or providing physical access to a facility). Each of the one or more booking times is specified in the request or determined by control system 110 as having an end time. For example, a booking time can have a start time and a duration or be specified in relation to another time or booking.

Control system 110 is configured to generate an access key in response to the request. The access key can be a code (e.g., QR code), device, or other component (e.g., using near field communication) that can be used to provide the requested access. Control system 110 is configured to store an association between the access key, the one or more booking times, and the one or more components 120 of the facility. The association can be stored in one or more local databases, in memory, or on a remote computer over a network 130, for example. Control system 110 is configured to enable requested access to the one or more components 120 of the facility upon receiving the access key during (or in a specified time in relation to e.g., 10 minutes before) the one or more booking times requested. Other attributes can be used to determine whether request should be enabled and the nature of the access provided.

Upon receiving the access key at a receiver component of the facility, control system 110 compares the one or more booking times with a present time and compares the one or more components 120 of the facility with the receiver component of the facility. The receiver component can include an access pad or electronic device at a physical door providing entry to the facility. The access key can be entered (e.g., via a keypad) or transmitted (e.g., wirelessly; via a short-range network, etc.) to the receiver component. If each of the comparing returns a comparison indicator representing matching, control system 110 is configured to enable access to the receiver component of the facility until one or more of the end times are met or have elapsed. For example, the access key can be provided to control system 110 wirelessly (e.g., infrared radiation) or via a wired connection at the receiver component and, if that receiver component is of the same type or is the same as the component 120 of the facility that was included in the request for the access key, control system 110 can enable access to the receiver component of the facility. Such access can include unlocking a door included as part of the receiver component, and the user can enter the facility through the door. If either of the comparing returns a comparison indicator representing no matching (e.g., if the access key was not provided at the component 120 to which access had been requested or if the present time is not within a booking time that the access key is configured to provide access in relation to), control system 110 is not configured to newly enable access. In some embodiments, control system 110 is configured to generate a negative validation indicator in that situation. The negative validation indicator can be used by control system 110 to transmit a notification to a user interface accessible by a user at a computer using an authenticated user profile.

Network 130 can be a near area or short range network or over an internet connection, for example. One or more components 120 of a facility are possible. One or more facilities are possible. Control system 110 includes one or more processors, computer memories, and can include non-transient computer readable media. A processor can execute instructions stored in one or more computer memories to implement the processes described herein.

Examples of the components 120 of the facility include a door for entry to the facility, equipment (e.g., golf clubs, storage rooms), or electrical devices.

In some embodiments, generating the access key is performed only upon successful validation of the request. In particular, the validation includes comparing the one or more booking times requested to one or more existing booking times and successful validation is when the one or more booking times does not overlap with a specified number of other existing booking times. For example, if only one or only five bookings are permissible at a given time or overlapping a given period of time in relation to the requested access of the component 120 (e.g., in relation to certain equipment or to access to the facility), validation will not be successful if the number of existing bookings at that time and in relation to the component 120 plus the requested booking exceeds that permissible number of bookings. Control system 110 can perform the validation or receive an indicator of validation performed at a remote computer.

In some embodiments, control system 110 is configured to transmit the access key to a remote computer and present the access key at a user interface accessible at the remote computer. For example, upon generating the access key, the access key can be sent to a user interface via email or accessible via a mobile application at a remote computer. A user can access the access key upon logging into a user profile to which the access key is associated.

In some embodiments, while access to the receiver component of the facility is enabled, control system 110 is configured to provide control of one or more configurable components of the facility to a user profile associated with the access key. The one or more configurable components can be specified with the request for access to the facility and can include equipment, lighting, temperature, devices, electrical components, and other components of the facility, for example. If same are not specified with the request, the one or more configurable components can be automatically determined by control system 110 after receiving the request and can be based on, for example, the time of the booking. For example, control of lighting in a certain section of the facility booked by the user can be provided if the booking is after 5 μm.

The configurable components can include lights, temperature control devices, smart devices, electrical devices, or any combination thereof. Other configurable components are possible. A component 120 of the facility can include a configurable component.

In some embodiments, control system 110 receives a request associated with a user profile for control of a configurable component of the facility. Control system 110 compares one or more booking times with a present time to determine a match. The one or more booking times are associated with the user profile and each have an end time or are determinable by control system 110 to have an end time. If a match is determined and an authorization indicator is present, control system 110 is configured to enable control of the configurable component until the end time of the booking time matched is met or has elapsed. The authorization indicator represents an authorization associated with the user profile for the configurable component.

In some embodiments, the authorization indicator is present only where the present time matches an authorization time.

In some embodiments, control system 110 configures the configurable component based on the request. For example, the request can be to turn off the lights in the entire facility and the control system 110 can turn off all of the lights in the entire facility in response.

As examples, the configuring can be to open a door, turn on or turn off an electrical component, or unlock the configurable component, such as equipment (e.g., golf carts).

As an example, according to some embodiments, the one or more components of the facility is one or more configurable components comprising lighting, temperature control devices, smart devices, electrical devices, or any combination thereof, and an access key is presented at a user interface (e.g., transmitted to a mobile device), where the access key is a configurable token for receiving a command to configure the one or more configurable components. For example, the configurable token can be a button displayed on the user interface that, upon engagement by a user (e.g., receiving a command at the user interface), turns on lights at the facility or unlocks certain equipment. Upon actuation of the access key in this way, the one or more configurable components are configured based on the command (e.g., lights are turned on based on a command received at the user interface by engagement with the access key to turn on the lights). Control system 110 is configured to automatically control or allow control of lights at the facility via smart power outlets, computers via network commands, sending of a command to any device connected on the local network, smart home devices, dimming lights, temperature, controlling audio equipment, controlling anything attached to a power outlet, security alarms, small appliances, door locks etc., for example.

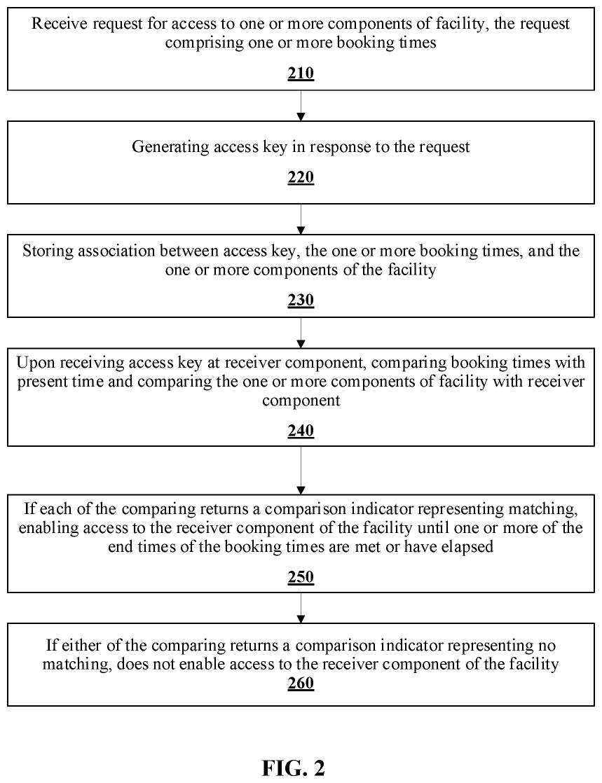

FIG. 2 is an example process implemented by control system 110, according to some embodiments. At 210, control system 110 receiving a request for access to one or more components of the facility, the request comprising one or more booking times, each of the one or more booking times determinable to have an end time. At 220, control system 110 generates an access key in response to the request. At 230, control system 110 stores an association between the access key, the one or more booking times, and the one or more components of the facility. At 240, upon receiving the access key at a receiver component of the facility, control system 110 compares the one or more booking times with a present time and compares the one or more components of the facility with the receiver component of the facility. At 250, if each of the comparing returns a comparison indicator representing matching, control system 110 enables access to the receiver component of the facility until one or more of the end times are met or have elapsed. At 260, if either of the comparing returns a comparison indicator representing no matching, control system 110 does not enable access to the receiver component of the facility.

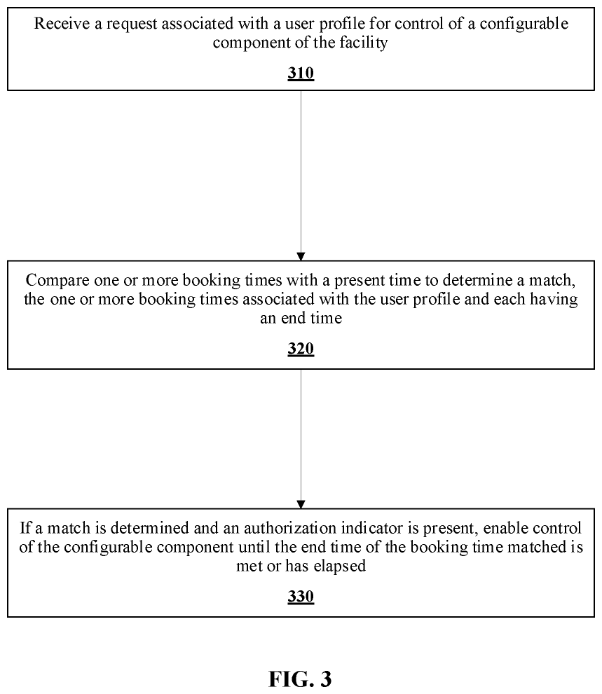

FIG. 3 is an example process implemented by control system 110, according to some embodiments. At 310, control system 110 receives a request associated with a user profile for control of a configurable component of the facility. At 320, control system 110 compares one or more booking times with a present time to determine a match, the one or more booking times associated with the user profile and each having an end time. At 330, if a match is determined and an authorization indicator is present, control system 110 enables control of the configurable component until the end time of the booking time matched is met or has elapsed. The authorization indicator represents an authorization associated with the user profile for the configurable component.

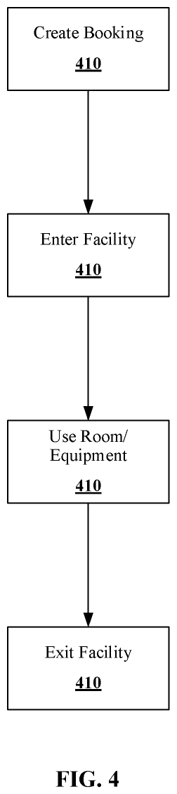

FIG. 4 is an example process for using the control system 110, according to some embodiments. The process illustrates a user's interaction with the control system 110. As shown, no other users (e.g., employees who have administrator access) are required to complete a cycle of use. The user is enabled to gain access to the facility and/or equipment at a requested booking time and/or control components of the facility, such as lighting, temperature, electrical devices, computer system, and technology. At 410, a request for a booking is generated by the user at a user interface of control system 110. At 420, the user presents the received access key at the facility and is enabled to enter the facility. At 430, the user is provided access to a room or section of the facility and/or equipment. Same can be enabled in association with the access key. At 440, the user can exit the facility. The access key can only be used to provide the requested associated access during the booking times requested, for example.

In some embodiments, a user profile can be simply a user identification. This can be an automatically generated code associated with data, for example.

In some embodiments, there is provided a control system 110 and computer-implemented method for automation and improved control of one or more facilities, including of a booking process at a facility, use of a facility, access to components 120 of a facility, and electrical components of a facility (e.g., lighting, doors, temperature, equipment, technology). By controlling the use of the specific facilities at a location, such as the entry door, specific lights, specific equipment, and specific technology, users can use a facility without requiring authorized staff to enable their use. For example, a user can golf and train at a facility without involving other human interaction.

This can not only allow for minimal human interaction but can also improve costs for maintaining and operating a facility, as well as increase the availability of services provided at the facility, such as to 24 hours per day and 365 days per year without an increase in labour costs.

For example, existing indoor golf ranges require staff to open the door for entry, charge customers, restrict access to rooms and equipment, manage technical issues, provide technical assistance, among other functions. Even where these tasks do not occur frequently, a full-time staff is required to be available at the facility. These tasks can be highly sporadic and their performance result in wasted labour hours and increased financial costs.

A booking time can be defined by a start time, an end time, a duration, another attribute, and/or any combination of same. Control system 110 is configured to implement an online scheduler that can create bookings or access a third party online scheduler. The online scheduler is configured to reserve a space for a user in response to a request for a booking and charge the user. Once the booking is created, the booking information is sent via an API to a database accessible by control system 110. Control system 110 is configured to receive booking information from a booking scheduler.

In some embodiments, the control system 110 provides for control of a user's use of components 120 of a facility. As an example, the control system 110 is configured to issue a smart door key that allows access limited to a specific time such as a booking time. This can allow a user to be issued the smart door key in advance of a booked time, where the smart door key does not enable access until the booked time. The user accordingly can be prevented from accessing the facilities simply anytime. As another example, the control system 110 can restrict access to or use of select equipment to a user's booked time. The user accordingly can be prevented from using the equipment outside the user's booked time. The user cannot book for 15 minutes and continue to use the equipment for hours following, for example, without obtaining further authorization from the system. Further authorization can be triggered by providing payment.

According to some embodiments, the control system 110 includes one or more databases that stores a customer, facility location, bay number, start and end time. The database can store variables associated with particular verified bookings, for example. Control system 110 is configured to allow for scheduling of commands or scripts based on the time. For example, at a specific time, a script is launched using all the other information, such as one or more fields stored in the database. For example, at 12:15 PM the “ON” program can be configured to run and obtain the facility location and bay number data, such as related to a particular booking or to pre-defined conditions. The program is configured to then turn ON all the required equipment based on these variables. If there is an error in the automation, the user can request access to the equipment using an app implementing access to control system 110. For example, if the light did not turn on, the user uses the app to turn it on manually. On receiving a command to configure equipment (e.g., turn on a light in a particular bay), data, such as the user information, date, and time are used to query the database to verify authorization. If validated, the control system 110 allows access to a URL to trigger the equipment. This URL can be unique to each component (e.g., equipment). Smart door keys can be URLs accessible to configure a component or equipment. Smart door keys can be queries into the control system 110 to grant access to the URL allowing access to a component or equipment (e.g., door URL). Other examples of smart door keys can include keypad codes or QR codes or transmitted using near field communication or can be other features allowing accessibility. Another example of a smart door key is a computer command that actuates the component or equipment (e.g., allows access, allows control, opens, etc.). For example, a command can be sent from control system 110, including from a remote computer (e.g., a user's mobile phone), to the component over a virtual private network without involving a public URL. A smart door key may not be a URL in some embodiments. The smart door key can be used to trigger a component. Where “URL” is used herein, it is to be understood that another type of trigger (e.g., smart door key) can be used, such as keypad codes or QR codes or other methods, such as near field communication.

As an example, according to some embodiments, once a booking is created and stored in one or more databases, the control system 110 is configured to run programs based on that data. The control system 110 can turn on lights or allow access to equipment automatically during a user's booking time, based on data stored in the one or more databases (e.g., booking times including original start times, original end times, and offset times from either of same; user identifiers; equipment or components needed during the booking, etc.). For door access, when the user opens the door page in an app at a user interface allowing access to the control system 110, a query is sent to the one or more databases which includes data such as a user identifier (e.g., user email or data generated based on same), according to some embodiments. If the user exists in the database and a booking exists and the current time is within the booking start and end times (including a time buffer from either of the original start time or the original end time), then the user is validated and receives access to the door key. The door key can be a URL that when actuated (e.g., accessed) sends a command to the control system 110 (e.g., at a remote computer at the facility) to unlock the door. The control system 110 includes an automation server that accepts external calls and is connected wired or wirelessly to various components of the facility, such as the door and lights and equipment.

According to some embodiments, there is no reliance on an access key for a door for entry to the facility being actuated in order to gain access to the other components such as lighting and equipment. It is possible for a user to arrive at the facility while someone is leaving and the user would simply enter the open door. At the user's start time (e.g., original start time of their booking), if not yet on or triggered, control system 110 is configured to automatically allow access or trigger components of the facility, such as turning on the lights or allowing access to equipment, based on the data stored in the one or more databases. For example, control system 110 can automatically query the database for booking durations that include the present time and trigger components of the facility (e.g., lighting, equipment, doors, etc.) accordingly. In such cases, user interaction may not be required to request access or control of the components of the facility in order for access or actuation (e.g., turning on lights) to be provided.

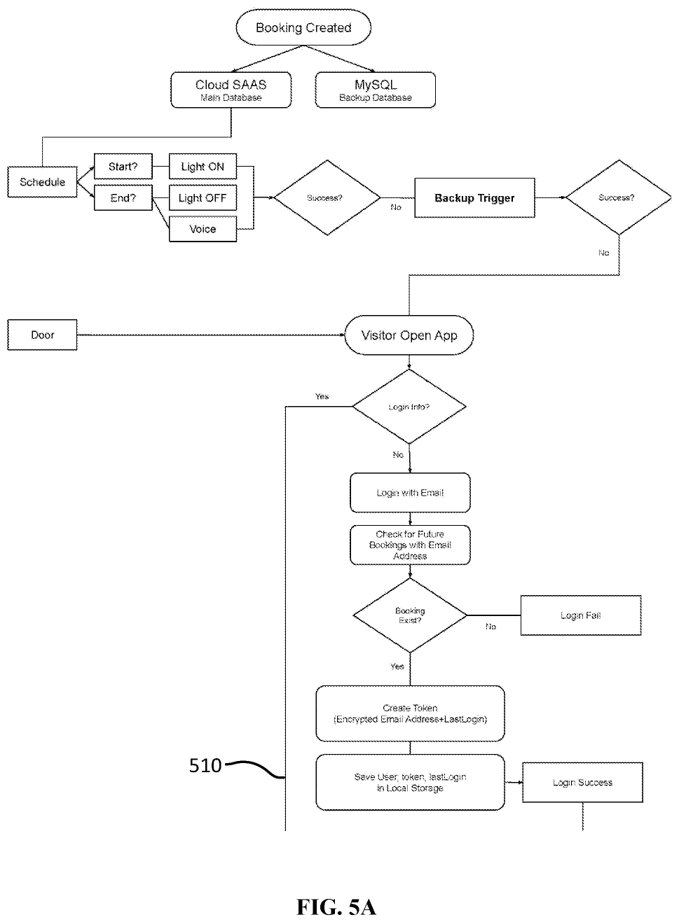

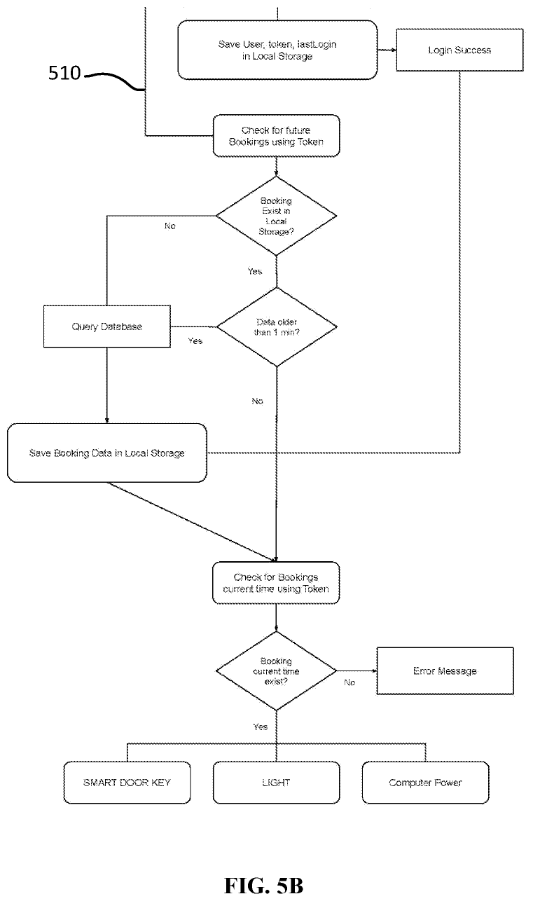

FIGS. 5A and 5B show an example process for control of a facility, according to an embodiment. As shown, a booking is created and stored in one or more databases. Control system 110 is configured to execute programs to control components of the facility, such as according to a schedule, using a comparison between the present time and a scheduled start and/or end time. For example, control system 110 can turn a light in a room of a facility on and/or off at the scheduled start and/or end times or do so in response to a voice command. Control system 110 is configured to execute backup processes, such as to check whether a component of the facility has been successfully actuated according to the schedule. If it has not been successfully activated (e.g., light has not been turned on), a backup trigger is activated to perform the function (e.g., turn the light on). Control system 110 is configured to receive a request from an application accessible at a user interface. The request can be generated by the application upon user access of the application or a corresponding page of the application, for example. For example, the user can open the application (or a relevant page of same) and the application can transmit a request for access to a door to the facility (e.g., for the door to be opened). Control system 110 is configured to validate the request by checking whether the request came from an application accessed using valid login credentials.

If it has not, the application may present a request for the user at the user interface to login with their credentials, such as an email address. Control system 110, such as at the application, can query the database as to whether any future booking exist that are associated with the login credentials (e.g., email address). If no bookings exist, the application can return an error message or indication that login has failed. If one or more bookings exist, control system 110 is configured to generate a token (e.g., based on the encrypted email address or login credentials and data related to the last login) and save data such as the token, a user identifier, and data related to the last login in storage, such as local storage. Control system 110 is configured to then save booking data in storage, such as local storage.

Alternatively, if the request is validated as it has come from an application accessed using valid login credentials, at 510, control system 110 is configured to check for whether any future bookings exist that are associated with the token (e.g., stored in a database and accessed from same) associated with the login credentials (e.g., email address). If a booking exists in local storage (e.g., in a computer such as a mobile device on which the application is accessed) and the data is older than a defined amount of time (e.g., 1 minute), or, alternatively, if a booking does not exist in local storage, control system 110 is configured to query a database and save the booking data in local storage. Alternatively, in some embodiments, the booking or booking data is not saved in local storage. A database, such as at a remote server, can be queried directly instead when determining whether a booking exists. Once the booking data is saved in local storage, control system 110 is configured to check (e.g., in the local storage) for whether a booking exists for the present time using the token. Alternatively, if a booking exists in local storage and the data is not older than a defined amount of time (e.g., 1 minute), control system 110 is configured to check for whether a booking exists for the present time using the token.

If a booking associated with the token does not exist for the present time, an error message is generated. If a booking associated with the token does exist for the present time, control system 110 is configured to automatically provide access to and/or configure one or more components of the facility, such as generate a smart door key and transmit same to a computer that can access a user account associated with the token, turn on a light in the facility, and turn on computer power at the facility.

According to some embodiments, administrator accounts are enabled with full remote access to all components of the facility using control system 110. Different layers of access to different components can be implemented using control system 110. This can allow an administrator account to be provided with access to and/or control of components of the facility, such as at a user interface. Upon actuation of a corresponding token at the user interface, a command can be sent to trigger an associated action at the facility, such as control of configurable components and/or access to components of the facility. This enables a fully automated, unstaffed facility. The control system 110 provides an ability to link a booking system with select equipment at a facility. A facility can be defined by a location, for example.

The control system 110 at a booking unit is configured to manage and store bookings for different users, such as defined by unique user identification attributes. The booking unit is configured to present, via a user interface, a request for specification or selection of one or more booking times. The user interface can be local or remote, such as at a remote computer or mobile device, for example. The booking unit is configured to receive data that can be used to define one or more booking times. Upon receiving the data, the booking unit is configured to define one or more booking times and perform validation of the booking time(s), such as by comparing the booking time(s) to existing booking time(s) stored in a database and/or one or more other attributes. The other attributes can include a maximum number of bookings permissible for the requested component of the facility (e.g., maximum number of bookings for a particular equipment, maximum number of total bookings permissible at the facility at a particular time), for example. If the requested booking time(s) are validated, the system is configured to transmit a notification to the user that includes a smart door key. For example, the notification can be transmitted by email and received at the user's computer.

According to some embodiments, booking unit is configured to implement an online scheduling software. Booking unit is configured to ensures there are no overlapping bookings. Booking unit is configured to accept payment for a booking request received, such as from a user interface. Booking unit is configured to accept payment for a booking at a later date, in some embodiments. For example, a user with a credit card can book such as using a mobile application included within or that can transmit data to control system 110. In some embodiments, bookings can only be requested by specific users, such as defined by a user identifier and/or command issued from a user account that is logged in. The users can be defined by being associated with a membership, for example. A user can log into the app using the same login credentials (e.g., email address) to create the booking as can be used to log into a separate app (or the same app) to request an access key, such as to obtain access to a component of the facility or configure a configurable component of the facility.

References to an app herein may include a single app or separate apps for separate features, according to some embodiments.

The smart door key is configured to trigger access to the facility, such as through an electronic exchange between the smart door key when presented at a door at the facility. The user can enter through the door at the booking time(s) corresponding to the smart door key. The control system 110 can enable this by comparing the present time to the booking time(s) and enable access only where the present time matches or falls within one or more booking time(s).

In some embodiments, the user can change the booking time(s) via the booking unit, and the control system 110 is configured to accordingly update the time(s) that the previously issued smart door key can be used to trigger access to the facility and/or issue a new smart door key to the user that triggers access to the facility at the updated booking time(s) while preventing access by the previously issued smart door key at the former booking time(s). Such access is enabled for the duration of the booking time(s). The control system 110 is configured to compare the present time with the end time of the present booking time at intervals or continuously in real-time and disable access once the end of the present booking time has occurred or has past, for example.

In some embodiments, the control system 110 is configured to permit access to select equipment or other components of the facility similarly as described for permitting access to the facility. For example, the control system 110 is configured to issue access keys rather than smart door keys, where the access keys can be used to trigger access to select equipment or other components rather than access to the facility. The control system 110 is configured to store, in association with an access key, associated booking time(s) and the equipment or other component for which the access key was issued. Upon receiving the access key (e.g., presented at the associated equipment or at a door to a room in which the associated equipment is stored at the facility), the control system 110 is configured to validate the access key, such as by comparing the present time, associated booking time, associated equipment or other component with which it is associated, and the equipment or door at which the access key is presented. If the access key is successfully validated, the control system 110 is configured to enable access to the associated equipment, such as by unlocking the associated equipment or unlocking a door to a room in which the equipment is stored. If the access key is not validated, the control system 110 is configured to not permit access to the associated equipment or component.

In some embodiments, control system 110 is connected, such as over a network 130, to a remote computer, such as a mobile device. Components of control system 110 can be implemented in a mobile application accessible on the mobile device. For example, the control system 110 and/or a booking system component of same can be accessible via the mobile application and can allow a user to have direct control over components of the facility. As such, an access key may not be provided to the user such as over email communication. Instead, the user may access control system 110 to enable access instead. For example, light and equipment can be controlled where there is a failure in the system. Permission for direct access can be enabled automatically by control system 110 based on the existence of a valid booking for the specific user. By providing direct access there is less reliance on remote workers.

This configuration can help avoid failures of a system and reduce burden on remote technical support. Examples include lights not turning on, projectors not turning on, computers being turned off by previous customers, customer errors in software use, and sending email keys to users when the email servers are slow or fail completely. These issues can limit the computer functionality to bookings only hours before the start time, as well as decrease reliability of the computer system.

In some embodiments, control system 110 transmits or provides an access key (e.g., by email or as accessible via an application) to a user and enables control by the user to turn on and/or off select equipment based on the user's booking time. Other users can also have remote control over components of the facility, including configurable components and can login to computers remotely.

Control system 110 can be implemented by a computer application. A computer application can provide for an authentication process to allow a user to login to the computer application and access control granted to them by control system 110. Control system 110 is configured to enable control in relation to specific users, such as using unique user identifiers or user profiles, including user accounts. Such control can be limited by control system 110 by a number of different attributes, such as by user and time.

In some embodiments, the computer application allows a user to cancel their own bookings and receive a refund.

As used herein, a computer or a remote computer includes a mobile device.

Various embodiments of the invention have been described in detail. Since changes in and or additions to the above-described best mode may be made without departing from the nature, spirit or scope of the invention, the invention is not to be limited to those details but only by the appended claims. Section headings herein are provided as organizational cues. These headings shall not limit or characterize the invention set out in the appended claims.

What is claimed is:

1. A computer-implemented method for controlling a facility, the method comprising:
receiving an authentication indicator representing authentication of a user login to a user account accessible from a mobile application at a user device;
receiving a request from the user account for access to one or more components of the facility;
generating one or more queries to one or more databases based on the request and to validate the request;
validating the request using the one or more queries to determine whether an access key should be granted;
if the access key should be granted, generating the access key and presenting the access key at a user interface of the mobile application, the user interface accessible using the user account;
upon actuation of the access key, enabling access to the one or more components of the facility.

2. The computer-implemented method of claim 1, wherein the request comprises a user identifier and a present time indicator.

3. The computer-implemented method of claim 1, wherein the validation further comprises:
(a) identifying a booking in the one or more databases, the booking for a user identifier associated with the user account; and
(b) determining whether a present time is in a range of times from a start time of the booking to an end time of the booking;
and wherein the access key should be granted where (a) and (b) are true.

4. The method of claim 3, wherein the start time includes an offset start time from an original start time of the booking and the end time includes an offset end time from an original end time of the booking.

5. The computer-implemented method of claim 1, wherein the access key is a URL, wherein upon access of the URL, the access key is actuated.

6. The computer-implemented method of claim 1, wherein the access key is a keypad code, a QR code, or is transmitted using near-field communication.

7. The computer-implemented method of claim 1, wherein enabling access to the one or more components of the facility further comprises transmitting a command to the one or more components of the facility.

8. The computer-implemented method of claim 1, wherein the request is generated upon access of a page on the user interface, the page corresponding to the one or more components of the facility.

9. The method of claim 3, wherein the user identifier is a user email address.

10. The computer-implemented method of claim 1, further comprising storing a booking in one or more of the one or more databases, the booking comprising an original start time, an original end time, and a user identifier.

11. The computer-implemented method of claim 1, wherein one or more of the one or more components of the facility comprise a door for entry to the facility or equipment or both.

12. The computer-implemented method of claim 1, wherein the one or more components of the facility is one or more configurable components; and wherein the access key is a configurable token for receiving a command to configure the one or more configurable components; and wherein the enabling of access is configuring the one or more configurable components based on the command.

13. A computer-implemented system for controlling a facility, the system comprising:
a computing device comprising a processor and a non-transitory computer-readable memory with instructions thereon which when executed carry out the steps of:
receiving an authentication indicator representing authentication of a user login to a user account accessible from a mobile application at a user device;
receiving a request from the user account for access to one or more components of the facility;
generating one or more queries to one or more databases based on the request and to validate the request;
validating the request using the one or more queries to determine whether an access key should be granted;
if the access key should be granted, generating the access key and presenting the access key at a user interface of the mobile application, the user interface accessible using the user account;
upon actuation of the access key, enabling access to the one or more components of the facility.

14. The computer-implemented system of claim 13, wherein the request comprises a user identifier and a present time indicator.

15. The computer-implemented system of claim 13, wherein the validation further comprises:
(a) identifying a booking in the one or more databases, the booking for a user identifier associated with the user account; and
(b) determining whether a present time is in a range of times based on a start time of the booking to an end time of the booking;
and wherein the access key should be granted where (a) and (b) are true.

16. The computer-implemented system of claim 13, wherein the access key is a URL, wherein upon access of the URL, the access key is actuated.

17. The computer-implemented system of claim 13, wherein the request is generated upon access of a page on the user interface, the page corresponding to the one or more components of the facility.

18. The computer-implemented system of claim 13, wherein the steps further comprise storing a booking in one or more of the one or more databases, the booking comprising an original start time, an original end time, and a user identifier.

19. The computer-implemented system of claim 13, wherein the one or more components of the facility is one or more configurable components; and wherein the access key is a configurable token for receiving a command to configure the one or more configurable components; and wherein the enabling of access is configuring the one or more configurable components based on the command.

20. A non-transient computer-readable medium containing computer-readable instructions which, when executed by a computer processor, perform a method of:
receiving an authentication indicator representing authentication of a user login to a user account accessible from a mobile application at a user device;
receiving a request from the user account for access to one or more components of the facility;
generating one or more queries to one or more databases based on the request and to validate the request;
validating the request using the one or more queries to determine whether an access key should be granted;
if the access key should be granted, generating the access key and presenting the access key at a user interface of the mobile application, the user interface accessible using the user account;
upon actuation of the access key, enabling access to the one or more components of the facility.
